(19) United States
(12) Patent Application Publication
(10) Pub. No.: US 2010/0041807 A1
(43) Pub. Date: Feb. 18, 2010

(54) OPTICAL MEMBER MANUFACTURING METHOD, OPTICAL MEMBER MANUFACTURING APPARATUS AND OPTICAL MEMBER

(75) Inventors: Noriko Eiha, Odawara-shi (JP); Seiichi Watanabe, Odawara-shi (JP); Masato Yoshioka, Odawara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/529,128

(22) PCT Filed: Mar. 28, 2008
(86) PCT No.: PCT/JP2008/056721

§ 371 Date: Aug. 28, 2009

(30) Foreign Application Priority Data
Mar. 30, 2007 (JP) 2007-095372

(51) Int. Cl. C08K 3/00; B29D 11/00; B29C 51/18

(52) U.S. Cl. 524/401; 264/1.1; 425/346

(57) ABSTRACT

A method for manufacturing an optical member from a powdery nano composite material, which includes a thermoplastic resin containing inorganic fine particles, is provided. The method includes: preparing an aggregated intermediate body by heating the powdery nano composite material; and forming the optical member having a finished shape by heat-press molding the intermediate body.

### TECHNICAL FIELD

The present invention relates to an optical member manufacturing method, an optical member manufacturing apparatus, and an optical member; and particularly, relates to a technique of forming an optical member by means of a nano composite material.

### BACKGROUND ART

With high performance, miniaturization, and cost reduction of recent optical information recording devices such as a portable camera, a DVD, a CD, and a MO drive, superior material and development of a process are greatly desired for an optical member such as an optical lens or a filter used in these optical information recording devices.

Particularly, a plastic lens is more lightweight and more difficult to crack than an inorganic material such as glass, and can be processed in various shapes, and can be produced at a low cost. Therefore, application of the plastic lens is rapidly spreading not only to a lens for glasses but also to the above optical lens. With this spread, in order to make the lens thin, it is required to increase a refractive index of the material itself, or to stabilize an optical refractive index in relation to thermal expansion and temperature change. Various approaches have been made in order to improve the optical refractive index and suppress the coefficient of thermal expansion and the optical refractive index in relation to the temperature change. For example, the approach of using, as lens material, a nano composite material in which inorganic fine particles such as metal fine particles are dispersed in a plastic resin has been made (Refer to, for example, JP-A-2006-343387, JP-A-2002-47425, JP-A-2003-155415 and JP-A-2006-213895).

In case that an optical member is formed by means of such the nano composite material, for an optical member requiring high transparency, when the inorganic fine particles are dispersed in the plastic resin, it is necessary to make a particle diameter of the inorganic fine particle smaller than at least a wavelength of the used light in order to reduce light scattering. Further, in order to reduce attenuation of transmission light intensity due to Rayleigh scattering, it is necessary to prepare and disperse a nano particle of which size is so uniform as to be 15 nm or less.

In order to prepare the nano composite material in which the inorganic fine particles are dispersed in the plastic resin, there are the following methods.

(1) The inorganic fine particles are directly put in the plastic resin and mixed therein.
(2) After the inorganic fine particles are mixed in a liquid solvent, the solvent is heated to be removed.
(3) After a monomer and the inorganic fine particles are mixed, the monomer is polymerized to contain the inorganic fine particles.

However, in the method (1), the particles agglomerate in case of high particle density, so that the produced optical member is not transparent; and in the method (3), shrinkage is large in the polymerizing time, and control of the shape is difficult, so that for example, a portable small-sized camera lens or a pick-up lens cannot molded with the necessary accuracy. In the method (2), a lens having the highest quality can be formed. However, it remains that it takes some time to remove the solvent in the conventional method (2).

Therefore, in a dry step of removing the solvent in the method (2), by atomizing and drying the solution including the inorganic fine particles, the surface area of the solution increases, whereby the solvent removing time is reduced. According to this method, the nano composite material can be fabricated in a comparatively short time with uniform properties. However, the obtained material is in the shape of fine powder, so that the powder flutters about, dust and the like are easy to mix in the powdery nano composite material, and clogging is easy to be caused in the conveying time. Therefore, handling in each step for molding the lens becomes difficult.

Further, in an optical element and a method of manufacturing the same described in the JP-A-2006-343387, a nano composite material in which fine particles are dispersed in a resin is injection-molded into a preform, and the preform is pressed thereby to manufacture an optical element. However, in case that the resin material including the fine particles is injection-molded, the fine particles may agglomerate partially, so that there is fear that a product does not become transparent. In order to prevent such the particle agglomeration, in case that the fine particles are bonded to resin material, fluidity lowers, so that injection-molding may become impossible.

As described before, by dispersing the nano particles in the resin material, the refractive index is increased, and the refractive index and volume in relation to the temperature change are stabilized. Though the refractive index and the thermal stability are improved by the increase in the addition amount of the fine particles, fluidity of the nano composite resin worsens contrarily. Particularly, in order to improve the refractive index, a large amount of fine particle must be dispersed, so that the fluidity worsens more.

Therefore, in case that the nano composite resin is injection-molded, the resin fluidity necessary for injection-molding is not obtained even at a high temperature, so that it is difficult to mold a good product.

### DISCLOSURE OF THE INVENTION

An object of the invention is to provide an optical member manufacturing method, an optical member manufacturing apparatus and an optical lens, in which the powdered nano composite material is readily molded into an optical member by heightening handling property thereof, and even material having bad fluidity can be stably formed into the optical member having the desired optical characteristics.

The above object of the invention can be achieved by the following optical member manufacturing methods.

(1) A method for manufacturing an optical member from a powdery nano composite material which includes a thermoplastic resin containing inorganic fine particles,
the method including:
preparing an aggregated intermediate body by heating the powdery nano composite material; and
forming the optical member having a finished shape by heat-press molding the intermediate body.

According to this optical member manufacturing method, since the agglomerate intermediate body is prepared by heating the powdery nano composite material, and the intermediate body is formed into the optical member having the finished shape by being heat-press molded, the powder is not handled in the optical member molding process, so that handling property improves. Further, by forming the agglomerate intermediate body from the powdery material, weight (volume) control of high accuracy required in forming of an optical member such as a lens can be readily performed. For example, for forming of an optical lens used in a small-sized camera mounted on a mobile telephone, it is necessary to control its weight with accuracy of 0.1 mg in relation to about 50 mg of total lens weight. However, since the powder readily moves, floats, and attaches, it is difficult to measure the weight of the material in the powdery state with high accuracy to mold the powder into the lens. In case that such the powder is formed as, for example, a rod-shaped (agglomerate) intermediate body, the weight measurement can be replaced with the length measurement which is easy in measurement with high accuracy, so that handling property can be greatly improved.

(2) The optical member manufacturing method according to (1), wherein one aggregate of the intermediate body is formed into one optical member.

According to this optical member manufacturing method, since one optical member is formed from one agglomerate intermediate body, the weight (volume) in the finished shape of the optical member can be set with high accuracy, and a manufacturing process is simplified.

(3) The optical member manufacturing method according to (1) or (2), wherein the powdery nano composite material has an average particle diameter of 1 mm or less.

According to this optical member manufacturing method, by using the powder having the average particle diameter of 1 mm or less, productivity can be heightened. Namely, in the nano composite powder, for example, in case that solution in which a resin and inorganic fine particles are dispersed is made into fine liquid droplets, and the liquid droplets are dried and made powdery, since the average particle diameter of the powder is 1 mm or less, the increase of the surface area quickens drying in this dry step.

(4) The optical member manufacturing method according to (1) or (2), further including, after the preparing of the intermediate body, preparing a preform having a shape close to the finished shape by heat-compressing the intermediate body,
wherein the forming of the optical member is performed by forming an optical function surface on both sides of the preform.

According to this optical member manufacturing method, after the intermediate body is heat-compressed thereby to prepare the preform having the shape close to the finished shape of the optical member, the optical function surfaces are formed on both surfaces of the preform by press molding. Therefore, the preform can be economically prepared by an inexpensive mold that does not require high accuracy. This preform is press-molded by a mold of high accuracy, whereby the optical function surfaces of high accuracy are surely formed on the both surfaces of the preform, and an optical member having excellent optical characteristics can be manufactured.

(5) The optical member manufacturing method according to any one of (1) to (4), wherein the preparing of the intermediate body includes: heating and melting the powdery nano composite material; extruding the melted nano composite material by extrusion molding; and cutting a volume of the extruded nano composite material to prepare the intermediate body.

According to this optical member manufacturing method, after the powdery nano composite material is heated and melted, the desired volume of the melted nano composite material is extruded by extrusion-molding and cut, thereby to prepare the intermediate body. Therefore, the intermediate body having the fixed cross section is formed, and weight (volume) control of high accuracy is readily performed. Namely, in place of the weight measurement of the powder which is difficult to be performed in a short time and with high accuracy, the length measurement of the intermediate body is performed, whereby the weight (volume) control can be readily performed with high accuracy.

(6) The optical member manufacturing method according to any one of (1) to (4), wherein the preparing of the intermediate body includes: heating and melting the powdery nano composite material; extruding a rod-shaped body of the melted nano composite material by extrusion molding, the rod-shaped body having a constant cross section; and cutting the rod-shaped body to prepare the intermediate body.

According to this optical member manufacturing method, after the rod-shaped body of the nano composite material having a constant cross section is manufactured by extrusion-molding, this rod-shaped body is cut, thereby to prepare the intermediate body. Therefore, by utilizing the fact that the length of the rod-shaped body having the fixed cross section is proportional to the volume thereof, the desired amount of the intermediate body can be readily prepared.

(7) The optical member manufacturing method according to (1) or (2), wherein the preparing of the intermediate body includes heat-compressing the powdery nano composite material to form an intermediate body having a shape close to the finished shape.

According to this optical member manufacturing method, the powdery nano composite material can be formed into the preform by an easy step, and while handling property in the sequential step is being heightened, the number of the whole steps can be reduced.

(8) An optical member manufacturing apparatus that forms an optical member from a powdery nano composite material which includes a thermoplastic resin containing inorganic fine particles, the apparatus including:
a first forming unit that accommodates the powdery nano composite material in a container and heats the powdery nano composite material to prepare an agglomerate intermediate body; and
a second forming unit including at least two molds having optical function surfaces to be transferred onto the intermediate body, wherein the intermediate body is sandwiched between the molds and heat-press molded.

According to this optical member manufacturing apparatus, there are provided the first forming unit which heats the powdery nano composite material accommodated in the container thereby to prepare the agglomerate intermediate body, and the second forming unit which transfers the optical function surface onto the both surfaces of the intermediate body by heat-press molding the intermediate body with it between at least the two molds. Namely, after the powdery nano composite material is molded into the intermediate body which is excellent in handling property, the optical functional surface is formed on the intermediate body. Therefore, while the increase in the number of steps is being suppressed, the optical member can be manufactured with high accuracy.

(9) The optical member manufacturing apparatus according to (8), wherein the first forming unit includes:
a heating unit that heats the powdery nano composite material accommodated in the container;
an extrusion-molding unit that extrusion-molds the nano composite material melted by heating; and
a cutting unit that cuts the extruded nano composite material by an amount.

According to this optical member manufacturing apparatus, after the powdery nano composite material accommodated in the container has been heated by the heating unit to make the melted nano composite material, the melted nano composite material is extruded by the extrusion-molding unit, and the extruded nano composite material is cut by the desired amount by the cutting means thereby to form the intermediate body. Therefore, the intermediate body can be readily formed continuously. Further, in case that the nano composite material is extruded from a pipe having the constant section, by measurement of the extruded length, the weight (volume) of the intermediate body can be controlled with high accuracy.

(10) An optical member molded by the optical member manufacturing method according to any one of (1) to (6).

According to this optical member, since the optical member is manufactured from the powdery nano composite material of which the weight (volume) is controlled with high accuracy, its optical member has high accuracy and excellent optical characteristics.

The optical member according to (10), wherein the optical member is a lens.

According to this optical member, the lens having the excellent optical characteristics can be readily obtained.

### ADVANTAGEOUS EFFECTS

According to an embodiment of the invention, the powdery nano composite material in which inorganic fine particles are contained in a thermoplastic resin is easy to be molded into the optical member by heightening handling property, and the optical member having stable optical characteristics can be molded.

### BRIEF DESCRIPTION OF DRAWINGS

FIG. 1 is a flowchart showing a schematic procedure of an optical member manufacturing method according to a first embodiment of the invention;

FIG. 2 is a main portion longitudinal sectional view of an intermediate body forming apparatus which forms an agglomerate intermediate body from nano composite powder;

FIG. 3 is a flowchart showing a procedure of forming the intermediate body by the intermediate forming apparatus;

FIG. 4 is an explanatory view showing operations of extruding the intermediate body by an amount;

FIG. 5 is an explanatory view showing a step of molding an optical member by compression-molding the intermediate body;

FIG. 6 is a flowchart showing a schematic procedure of an optical member manufacturing method according to a second embodiment of the invention;

FIG. 7 is an explanatory view showing a step of molding a preform by heat-compressing an agglomerate intermediate body;

FIG. 8 is an explanatory view showing a step of molding an optical member from the preform by a compression-molding apparatus;

FIG. 9 is a flowchart showing a schematic procedure of an optical member manufacturing method in a third embodiment;

FIG. 10 is an explanatory view showing a step of molding a preform directly from a nano composite powder by heat-compressing the nano composite powder; and

FIG. 11 is a diagram showing a schematic procedure of an optical member manufacturing method in a fourth embodiment, in which an example of a step of preparing a rod-shaped nano composite material of which the cross section is fixed and cutting the rod-shaped nano composite material to prepare an intermediate body is shown,

wherein description of some reference numerals and signs are set forth below.
15 Piston (extrusion unit)
19 Hopper (container)
21 Heater (heating unit)
31 Cutter (cutting unit)
33 Upper mold
33a Optical function transfer surface
35 Lower mold
35a Optical function transfer surface
41 Upper mold
43 Lower mold
51 Upper mold
53 Lower mold
61 Nano composite powder
61A Fluidized nano composite material
63 Intermediate body
65 Preform
67 Optical member
67a Optical function surface
100 Intermediate body forming apparatus (first forming unit, optical member manufacturing apparatus)
200 Compression-molding apparatus (second forming unit, optical member manufacturing apparatus)
300 Preform molding apparatus (optical member manufacturing apparatus)
400 Preform molding apparatus (optical member manufacturing apparatus)

### BEST MODE FOR CARRYING OUT THE INVENTION

Exemplary embodiments of an optical member manufacturing method and an optical member manufacturing apparatus according to the invention will be described below in detail with reference to drawings.

A gist of the invention which will be described in the following embodiments is that: when an optical member is formed from nano composite material which can form an optical member having excellent transparency, a high refractive index, and excellent optical characteristics, the powdery nano composite material which is difficult in handling is once formed into an intermediate body which is easy in weight (volume) control, and thereafter the intermediate body is molded into an optical member, whereby an optical member having high accuracy can be manufactured.

### First Embodiment

First, a first embodiment of an optical member manufacturing method according to the invention will be described.

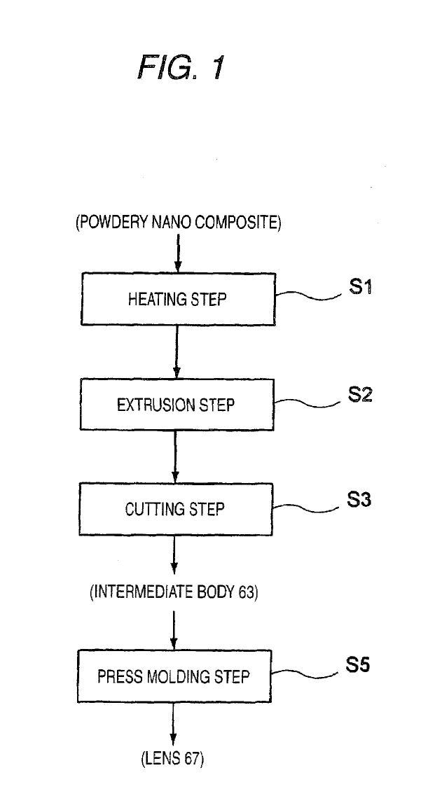

FIG. 1 is a flowchart showing a schematic procedure of the optical member manufacturing method according to the first embodiment of the invention.

As shown in FIG. 1, a nano composite powder is formed into an agglomerate intermediate body 63, by an intermediate body forming apparatus which will be described later, through a heating step (step 1: S1), an extrusion step (S2), and a cutting step (S3). Next, the intermediate body 63 is heated and compressed by press-molding (S4), whereby an optical member 67 such as a lens is manufactured. The nano composite powder is material in which inorganic fine particles each having average particle size of from 1 to 15 nm are dispersed in a thermoplastic resin, of which the detail will be described later.

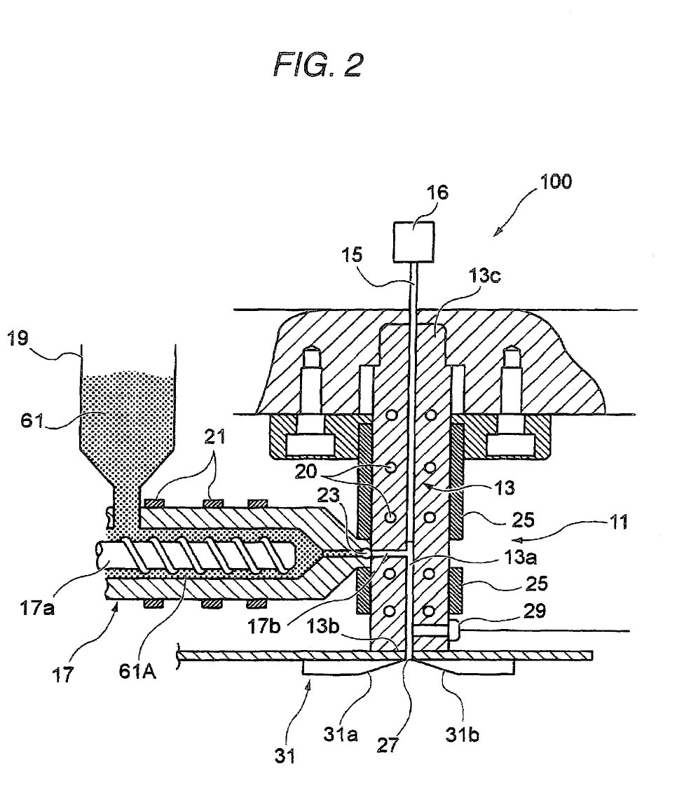

The above steps will be described below in order. First, the heating step S1, the extrusion step S2, and the cutting step S3 are performed by the intermediate body forming apparatus shown in FIG. 2. FIG. 2 is a main portion longitudinal sectional view of the intermediate body forming apparatus which forms an agglomerate intermediate body from the composite powder. The constitution shown in FIG. 2 is an example, and the invention is not limited to this constitution.

An intermediate forming apparatus 100 that is a first molding unit, which heats a nano composite powder 61 thereby to mold the agglomerate intermediate body 63, includes a material ejection mechanism 11. A cylinder 13 of the material ejection mechanism 11 has a through-hole 13a extending from a lower end portion 13b to an upper end portion 13c in the up-down direction. The shape of the transverse section of this through-hole 13a is constantly circular, and a diameter (cross section) of its transverse section is uniform throughout the whole of the through-hole 13a.

It is desirable that the diameter of the transverse section of the through-hole 13a is 10 mm or less, and actually about from 0.5 to 7 mm. In case that the diameter of the transverse section of the through-hole 13a is smaller, measurement of high accuracy is possible. However, in case that it is too small, the ejection volume per one shot decreases, so that plural shots are required, and it takes the extra measuring time.

Into the through-hole 13a of the cylinder 13, a part of a piston 15 is inserted from the upper end portion 13c. The piston 15 which extrudes a nano composite material 61A melted by heating has an elongated shape of which the sectional shape is nearly the same as that of the cylinder 13, and the piston 15 can slide into the through-hole 13a in the up-down direction. The piston 15, of which the base end side is connected to a piston up-down mechanism 16 which is driven by a servo motor or a stepping motor, slides into the cylinder 13 in the up-down direction. Further, the material ejection mechanism 11 includes a not-shown displacement sensor, and the moving distance in the stroke direction of the piston 15 is detected by the displacement sensor. As the displacement sensor used for measurement of the moving stroke, for example, an optical sensor such as a laser displacement meter, a contact type sensor, an electrostatic capacity sensor, and the like can be used. These cylinder 13, piston 15, piston up-down mechanism 16, displacement sensor function as an extrusion-molding unit.

On the other hand, to a part of a peripheral surface of the cylinder 13, a plasticizing mechanism 17 is coupled. The plasticizing mechanism 17 includes a hopper 19 for storing the nano composite powder 61 which is raw material of a product. On the peripheral surface of the plasticizing mechanism 17, a heater 21 is provided as a heating unit which heats and melts the nano composite powder 61 thereby to make the nano composite material 61A fluidized.

The plasticizing mechanism 17 melts the nano composite powder 61 by heat from the heater 21 and frictional heat between the materials thereby to produce the fluidized nano composite material 61A having fluidity, leads the nano composite material 61A to the front on the ejection side while stirring the nano composite material 61A by means of a screw 17a, and ejects the nano composite material 61A toward the through-hole 13a of the cylinder 13. The nano composite material 61A ejected toward the through-hole 13a is fed through a flowing path 17b into the through hole 13a of the cylinder 13. Midway of the flowing path 17b, a check valve 23 for preventing reverse flow of the nano composite material 61A to the plasticizing mechanism 17 side is provided. The temperature of the plasticizing part is desirably in a range of from (a glass transition temperature Tg−20° C.) to (Tg+200° C.), more desirably in a range of from Tg to (Tg+150° C.), and still more desirably in a range of (Tg+20° C.) to (Tg+120° C.). In order to the fluidity of the material, soluble gas such as oxygen dioxide or nitrogen may be introduced at a high pressure.

Inside the cylinder 13, a heater 20 is embedded in order to keep the temperature of the nano composite material 61A at the glass transition temperature or more. At the periphery of the cylinder 13, an insulating material 25 for keeping the temperature is provided in an appropriate placement position.

Near an ejection port 27 between the lower end portion 13b of the cylinder 13 and the meeting point of the through-hole 13a of the cylinder 13 and the flowing path 17b extending from the plasticizing mechanism 17, a pressure sensor 29 is installed at an opening portion communicating with the through-hole 13a. The pressure sensor 29 detects the pressure applied to the nano composite material 61A near the ejection port 27.

Further, around the ejection port 27, a cutter 31 is installed as a cutting unit for cutting the ejected nano composite material 61A. The cutter 31 consists of a pair of blades 31a, 31b arranged on the right and left of the ejection port 27. The blades 31a, 31b reciprocate, whereby the nano composite material 61A ejected from the ejection port 27 is cut.

The cutter 31 has been heated at the temperature (range of from (Tg+20° C.) to (Tg+130° C.)) which is higher a little than the glass transition temperature Tg of the nano composite material 61A. This is because: in case that the temperature of the cutter 31 is the normal temperature, the nano composite material 61A hardens from the blade portion and the nano composite material 61A scatters in the cutting time; and in case that the temperature of the cutter 31 is too high, the nano composite material 61A sticks to the blades 31a, 31b of the cutter 31.

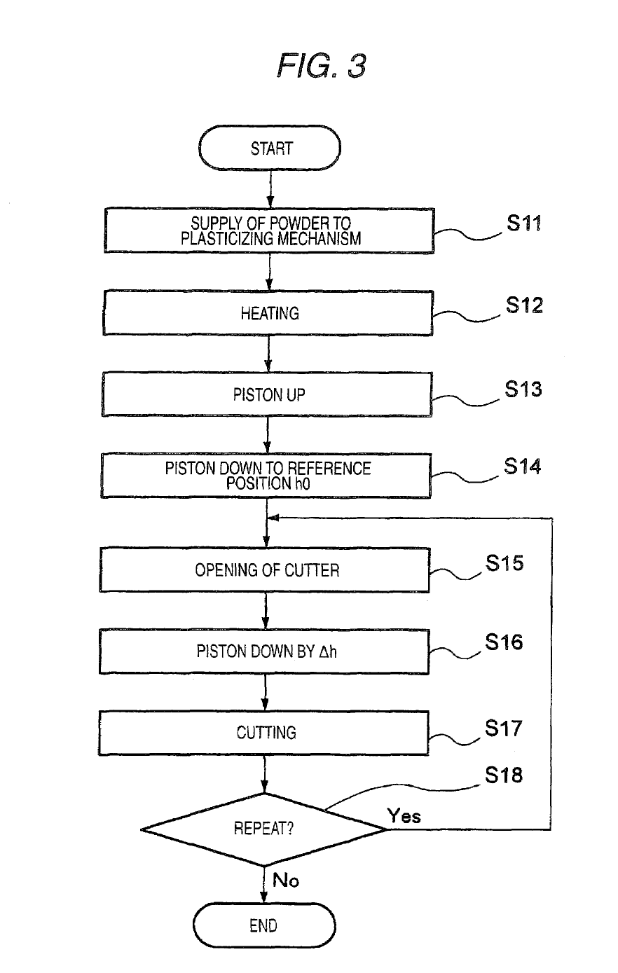

The contents of each step in a procedure of forming the intermediate body 63 by the thus-constructed intermediate body forming apparatus 100 will be described with reference to FIGS. 3 to 5.

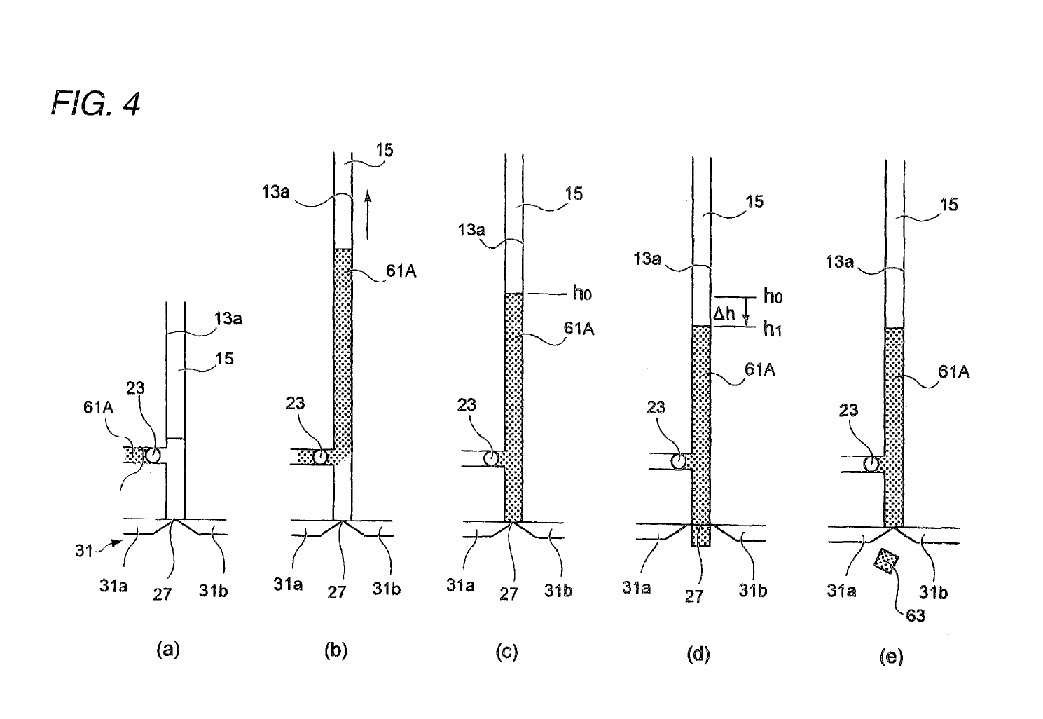

FIG. 3 is a flowchart showing a procedure of forming the intermediate body by the thus-constructed intermediate body forming apparatus, and FIG. 4 is an explanatory view showing the operation of extruding the intermediate body by the predetermined amount.

As shown in FIG. 3, in order to prepare the intermediate body 63, first, the nano composite powder 61 stored in the hopper 19 is supplied to the plasticizing mechanism 17 (S11). Next, the nano composite powder 61 is heated by the heater 21, and gives the fluidity to the nano composite powder 61 thereby to make the fluidized nano composite material 61A (S12). At this time, the piston 15 inserted into the through-hole 13a of the cylinder 13 is located, as shown in FIG. 4(a) at the upper part of the flowing path 17b communicating with the inner space of the plasticizing mechanism 17 and the through-hole 13a of the cylinder 13 (on the upstream side of extrusion).

It is preferable that the hopper 19 which puts the material in the plasticizing mechanism 17 is subjected to vibration (ultrasonic vibration, physical forced vibration, or the liked) so that the flow of the nano composite powder 61 to the screw 17a does not stop. Further, in order to feed forcedly the nano composite powder 61 to the screw 17a, another screw may be provided separately from the shown screw 17a, or a pump may be used to feed the nano composite powder 61. Further, since the nano composite powder 61 is readily soluble due to heat, it is preferable that the nano composite powder 61 is cooled by water or the like up to the position immediately before the plasticizing part of the plasticizing mechanism 17 to prevent the heat by the plasticizing part from transmitting to the nano composite powder 61 up to its position.

Next, as shown in FIG. 4(b), on the basis of the positional information detected by the aforesaid displacement sensor (not shown), the piston 15 is moved up in the through-hole 13 by the piston up-down mechanism 16, and the screw 17a is rotated thereby to eject the nano composite material 61A fluidized by heating to the through-hole 13a of the cylinder 13. Hereby, the through-hole 13a is filled with the nano composite material 61A (S13). In the filling time of the nano composite material 61A, the cutter 31 is in a closed state.

Next, as shown in FIG. 4(c), the piston 15 is moved down to a reference position h0 in a state where the cutter 31 is closed, and presses down the lower end of the nano composite material 61A poured in the through-hole 13a to the position of the ejection port 27 (S14). At this time, the check valve 23 is closed to prevent the reverse flow of the nano composite material 61A to the plasticizing mechanism 17. Further, by protruding the nano composite material 61A a little from the ejection port 27, its protruded portion may be cut by the cutter 31 to adjust the end surface of the nano composite material 61A.

Next, as shown in FIG. 4(d), the blades 31a and 31b of the cutter 31 are separated to open the ejection port 27 (S15), and the piston 15 is moved down by a predetermined distance Δh (between the reference position h0 and h1) on the basis of the positional information detected by the displacement sensor (S16). Hereby, the nano composite material 61A poured in the through-hole 13a of the cylinder 13 is gradually ejected from the ejection port 27. The nano composite material 61A ejected from the ejection port 27 is heated by the heater 20 inside the cylinder 13 at the temperature equal to or higher than the glass transition temperature.

Next, as shown in FIG. 4(e), the cutter 31 is driven, thereby to cut the nano composite material 61A ejected from the ejection port 27 and separate the cut portion from the nano composite material 61A in the through-hole 13a (S17). The cut-off nano composite material is utilized as an intermediate body 63 for compression-molding, which will be described later.

The pressure of the nano composite material 61A in the through-hole 13a increases with the movement of the piston 15. Therefore, it is desirable that: after the movement of the piston 15 has been stopped, the pressure sensor 29 confirms that the pressure decreases to the normal pressure, and thereafter cutting of the nano composite material 61A is performed. Hereby, an influence of density change of the nano composite material 61A, which is produced by the pressure is eliminated, so that a columnar intermediate body 63 of which weight (volume) has been measured with higher accuracy is obtained. Further, cutting by the cutter 31 may be performed in a state where the nano composite material 61A ejected from the ejection port 27 is hot or after cooling the nano composite material 61A ejected from the ejection port 27. However, considering energy loss, cutting in the hot state is preferable. Further, the shape of the intermediate body 63 is not limited to the columnar shape in the shown example, but may be the shape of a rod. In case of the rod-shaped intermediate body 63, it further cut in a dimension close to the finished shape (lens) by an appropriate cutting unit, and the cut part is used as an intermediate body 63 in the sequential stage. Further, in case that the ejected nano composite material is rod-shaped, the shape of the intermediate body 63 may be adjusted by a cutting unit or may be adjusted by thermal deformation due to heating.

Further, in case that the intermediate body 63 is handled at the glass transition temperature or more, it is desirable that a grip portion which grasps the intermediate body 63 is formed of non-adhesive material. Specifically, as the non-adhesive material, a fluorocarbon resin or a material which is small in contact area by thermal spraying is applicable. Further, in order to keep the temperature of the intermediate body 63 high, it is desirable that the grip portion is previously heated at the almost same temperature as the temperature of the intermediate body 63.

The above operation is repeated till the previously set number of intermediate bodies 63 are obtained (S18). Further, as ejection modes, there are various patterns other than the above-mentioned pattern in which plural times of ejection are performed by one time of the nano composite material filling. For example, there are a pattern in which one time of the filled material is used up by one ejection, and a pattern in which one intermediate body 63 is prepared by plural times of filling. These patterns can be appropriately used according to the size of the intermediate body 63 or accuracy of the set volume.

As described above, in case that the density and the temperature of the fluidized nano composite material 61A are constant, a proportional relation is satisfied between the weight of the intermediate body 63 and the volume obtained as the product of the transverse area of the inner space of the through-hole 13a and the movement stroke of the piston 15, and the weight measurement of the intermediate body 63 can be replaced with the movement stroke measurement of the piston, so that the weight (volume) control can be performed with high accuracy. For example, even in case that an optical lens used in a small-sized camera is molded under the weight control with accuracy of 0.1 mg in relation to lens total weight of about 50 mg, the weight (volume) control is performed by the length measurement which is easy in high-accuracy measurement. Therefore, the optical lens having the desired shape can be molded with high accuracy without lowering the optical characteristics.

In the above example, though the extrusion direction is a downward direction, it is not limited to this direction, but it may be an upward direction or a lateral direction. In case of the upward direction, since the shape of the extruded material becomes close to the more globular shape, its material is easy to be worked into a lens.

The intermediate body 63 prepared by the intermediate body forming apparatus 100 one by one with the measurement of high accuracy is grasped by a not-shown handling mechanism and sent to a next step; a press molding step. The intermediate body 63 is molded into an optical member 67 through the press molding step which will be described next. Hereby, since the powdery material is replaced with the agglomerate material, handling property of the material during each step can be greatly improved. In case that the intermediate 63 is carried while being keep at the temperature equal to or higher than the glass transition temperature Tg (at highest about Tg+30° C.), the heating time in the next step can be reduced.

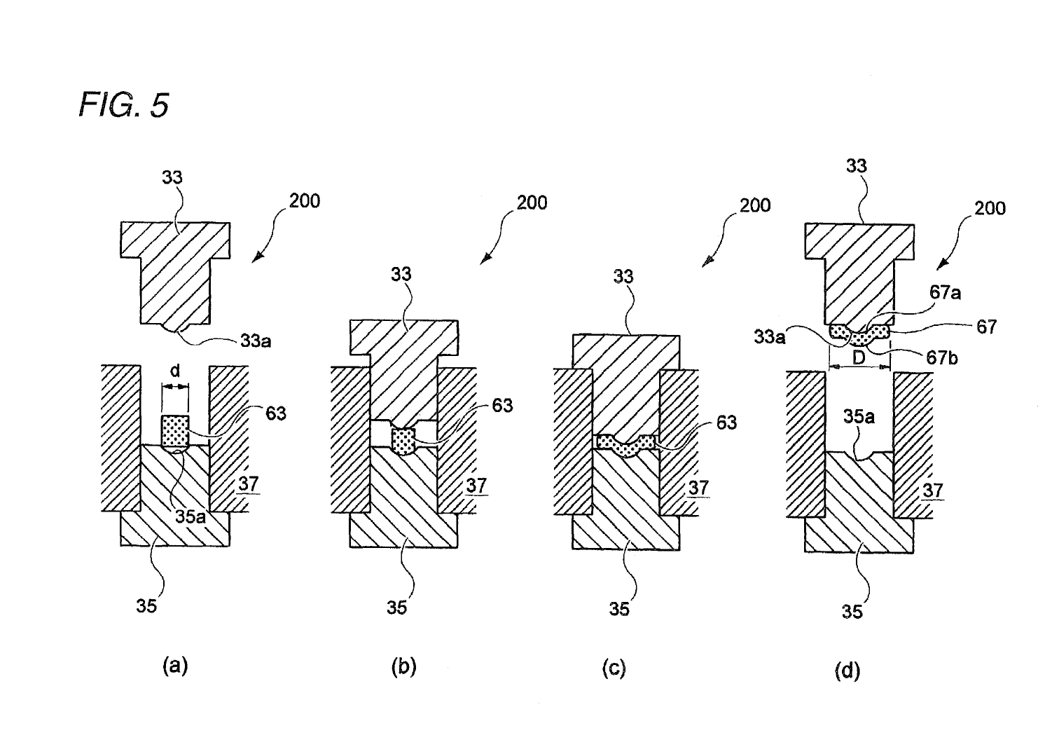

FIG. 5 is an explanatory view showing a step of molding an optical member by compression-molding (press-molding) the intermediate body.

A compression-molding apparatus (press-molding apparatus) 200 which is a second molding unit includes at least two molds; an upper mold 33 and a lower mold 35. In this embodiment, the apparatus 200 includes three molds including the above molds 33, 35 and an external mold 37 into which the upper mold 33 and the lower mold 35 fit. On a lower surface of the upper mold 33 and an upper surface of the lower mold 35, optical function transfer surfaces 33a, 35a for respectively transferring optical function surfaces (lens surfaces) 67a, 67b to an optical member 67 are formed with high dimensional accuracy. Further, this compression-molding apparatus 200 includes a not-shown heating mechanism for heating each mold.

In order to mold the optical mold 67 from the intermediate body 63, as shown in FIG. 5(a), in a state where the molds 33, 35 are separated from each other, one intermediate body 63 formed by the intermediate body forming apparatus 100 is put on the lower mold 35 fitted into the external mold 37. At this time, the intermediate body 63 is put in the center of the mold. After the intermediate body 63 put in the molds has been heated to the predetermined temperature, as shown in FIG. 5(b), the upper mold 33 is moved toward the lower mold 35. Hereby, as shown in FIG. 5(c), the intermediate body 63 is pressed in the external mold 37 and between the upper mold 33 and the lower mold 35 thereby to be molded in the shape of a product. Next, after the intermediate body 63 has been cooled under a pressurized state, as shown in FIG. 5(d), the upper and lower molds 33, 35 are opened, and the compression-molded (press-molded) lens (optical member) 67 is taken out. As the heating method of the intermediate body 63, conduction heat transfer by heating the mold, a method of heating the intermediate body 63 by laser or infrared rays, or the like can be appropriately used, and its heating method is not particularly limited. As the type of heating the mold, in order to perform heating and cooling at a high speed and with high accuracy, a type in which a heat block is used to perform the conduction heat transfer, or a type in which the mold is directly heated by radio-frequency induction heating is used. However, the mold heating type is not particularly limited.

The temperature of the intermediate body 63 in the press molding time is preferably in a range of from (the glass transition temperature Tg) to (Tg+250° C.), more preferably in a range of from Tg to (Tg+200° C.), and still more preferably in a range of from (Tg+20° C.) to (Tg+150° C.). In case that the temperature of the intermediate body 63 is high, not only it takes time to cool the intermediate body 63 and productivity lowers, but also the material deteriorates due to heat and problems of coloring and decrease in transparency are produced. To the contrary, in case that the temperature is too low, double refraction is produced by pressing, so that quality as a lens lowers. The press in the press-molding time is performed in a state where the press power is in a range of from 0.005 to 100 kg/mm², preferably in a range of from 0.01 to 50 kg/mm², and still more preferably in a range of from 0.05 to 25 kg/mm². The press speed is from 0.1 to 1000 kg/sec.; and the press time is from 0.1 to 900 sec., preferably from 0.5 to 600 sec., and more preferably from 1 to 300 sec. Further, the press start timing may be immediately after heating, or after a fixed time for the purpose of uniform heating (to make the temperature of the intermediate body uniform to the inside thereof).

The temperature of the mold when the intermediate body 63 is put in the compression-molding apparatus may be higher or lower than the glass transition temperature Tg. However, it is preferable that the mold temperature is higher, because heating of the intermediate body 63 is completed in a short time. Further, since the intermediate body 63 shrinks in the cooling time, pressing is performed in accordance with progress degree of cooling, whereby the mold shape (optical function transfer surface 33a, 35a) can be transferred with higher accuracy. For example, the temperature of the mold or the intermediate body 63 is detected, and in accordance with this detected temperature, the press speed may be controlled. Further, the weight of the intermediate body 63 put in the compression-molding apparatus 200 is controlled within a range of very small variation by measuring the movement stroke of the piston 15 of the intermediate body forming apparatus 100 with high accuracy. The size (diameter d) of the intermediate body 63 is preferably ¼ to ¾ as large as the diameter D of the optical member (lens) 67, and more preferably about ½ considering moldability.

In the optical member manufacturing method in this embodiment, from the nearly columnar intermediate body 63, the optical member 67 that is a finished product is formed by one time of compression-molding. Therefore, it is necessary to manufacture, with high accuracy, the molds of the compression-molding apparatus 200, and particularly the optical function transfer surfaces 33a, 35a which transfer the optical function surfaces 67a, 67b. Further, in order to transfer the optical function surface 67a, 67b satisfactorily, it is desirable that the shape of the optical member is given to the intermediate body while the intermediate body is being cooled at a comparatively slow speed, for example, at from 5 to 50° C./min under the temperature Tg or more.

As described above, according to the embodiment, when the optical member is formed from the nano composite material which can form the optical member having excellent transparency, a high refractive index, and excellent optical characteristics, the powdery nano composite material which is difficult in handling is formed into the intermediate body which is easy in weight (volume) control, whereby handling property can be improved. Further, since the weight (volume) of this intermediate body can be set with high accuracy, the thickness of the optical member to be formed can be made in conformity to the design, so that it is possible to manufacture the optical member having high performance and high accuracy.

### Second Embodiment

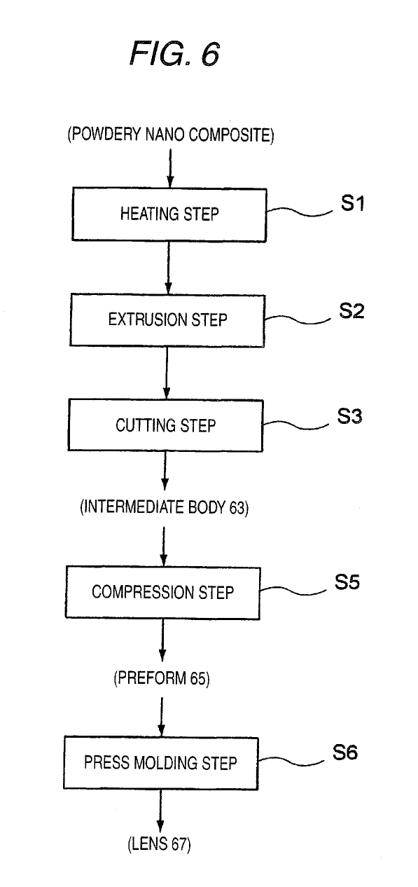

Next, a second embodiment of the optical member manufacturing method according to the invention will be described with reference to FIGS. 6 to 8.

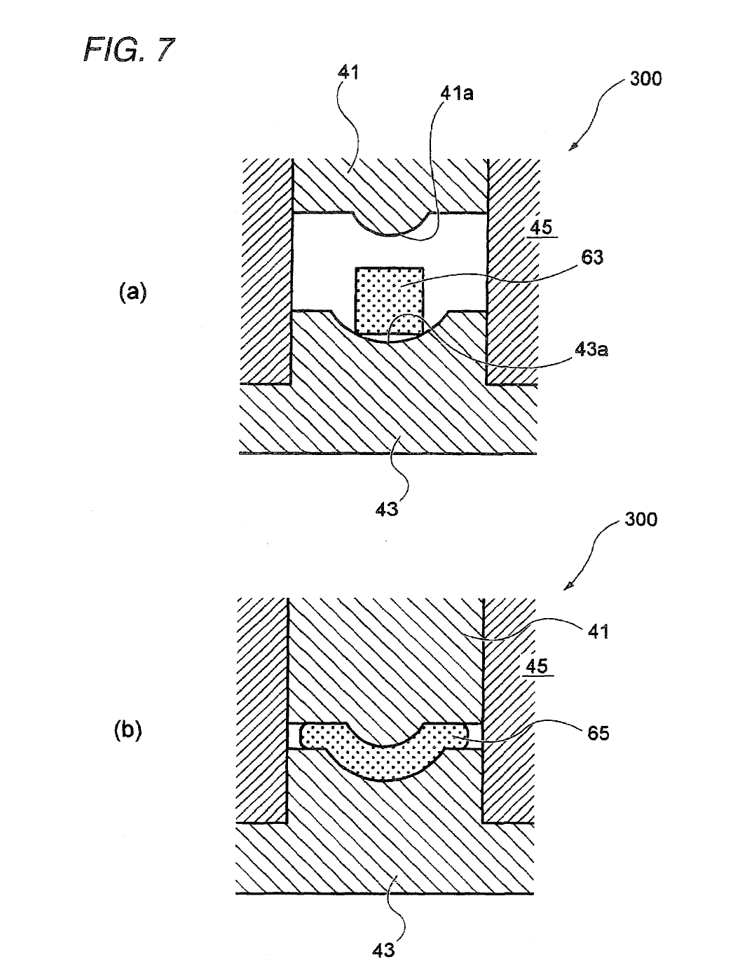

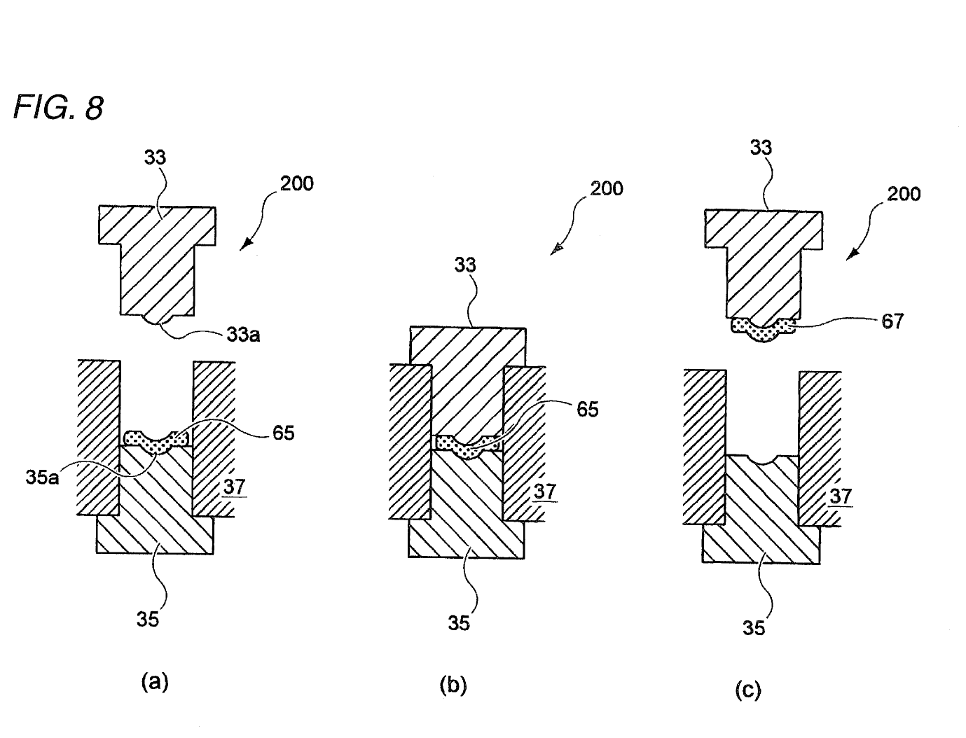

FIG. 6 is a flowchart showing a schematic procedure of the optical member manufacturing method according to the second embodiment of the invention, FIG. 7 is an explanatory view showing a step of molding a preform by heat-compressing an agglomerate intermediate body, and FIG. 8 is an explanatory view showing a step of molding an optical member from the preform by a compression-molding apparatus (press-molding apparatus).

In the optical member manufacturing method in the embodiment, as shown in FIG. 6, through a heating step (S1), an extrusion step (S2), and a cutting step (S3) which are similar to those in the first embodiment, an agglomerate intermediate body is formed. Next, the intermediate body is compressed in a compression step S5 thereby to be molded into a preform having the shape close to the shape of an optical member (lens). Thereafter, the preform is pressed in a press-molding step (S6) thereby to manufacture an optical member that is a finished product. This embodiment is different from the first embodiment in the compression step (S5) and the press-molding step (S6).

The above heating step (S1), extrusion step (S2) and cutting step (S3) which form an intermediate body 63 from a nano composite powder 61, and an intermediate body forming apparatus are the same as those shown in FIGS. 1 to 5. Therefore, their description is omitted.

As shown in FIGS. 6 and 7, the intermediate body 63 formed by an intermediate body forming apparatus 100 under weight (volume) control is sent to a preform molding apparatus 300 which executes working in the compression step (S5), and molded into a preform 65. The preform molding apparatus 300 includes an upper mold 41, a lower mold 43, and an external mold 45 to which the upper mold 41 and the lower mold 43 are fitted. A lower surface 41a of the upper mold 41 and an upper surface 43a of the lower mold 43 are formed respectively in the shape close to the shape of the optical member 67 that is a finished product. However, as long as the preform molding apparatus 300 can mold the intermediate body 63 in the shape close to the shape of the optical member 67, the lower surface 41a of the upper mold 41 and the upper surface 43a of the lower mold 43 do not require comparatively accuracy in their shapes. Accordingly, the manufacturing cost of the molds is inexpensive.

As shown in FIG. 7, the intermediate body 63 formed by the intermediate body forming apparatus 100 is put on the lower mold 43 arranged in the external mold 45, and pressed between the upper mold 41 and the lower mold 43, thereby to be molded into a preform 65 (S6).

When the preform 65 is molded, in case that the mold for the preform 65 is concave (in case of a convex lens), it is desirable that a curvature of the preform 65 surface is made larger than the product shape. Further, press conditions in the preform 65 molding time are similar to those in the press molding step of the intermediate body 63 in the first embodiment.

As shown in FIG. 8, the preform 65 molded in the shape close to the shape of the optical member 67 is put on a lower mold 35 of a compression molding apparatus 200 constructed similarly to the apparatus which has been already described in FIG. 5, and pressed in an external mold 37 between a upper mold 33 and the lower mold 35 while being heated, thereby to be molded in the product shape (FIG. 8(b)). After the preform has been cooled in a pressurized state, the upper and lower molds 33, 35 are opened, and an optical member 67 which is a product obtained by compression molding is taken out (FIG. 8(c)).

According to the optical member manufacturing method in this embodiment, since the optical member 67 that is the product is molded stepwise by two times of compression molding, strain is difficult to remain, and there is a tendency for the optical member 67 having higher accuracy to be made readily. Further, in addition, the operational advantage similar to that in the manufacturing method in the first embodiment is obtained. Further, even an optical member having the shape (for example, a biconvex lens) which is difficult to form in the first embodiment can be made with high accuracy.

### Third Embodiment

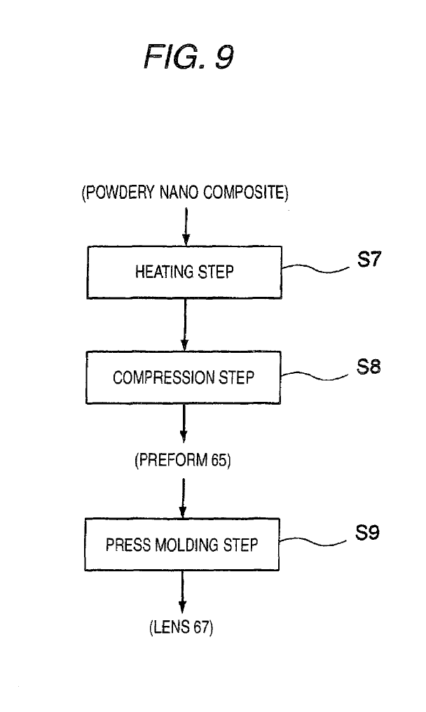

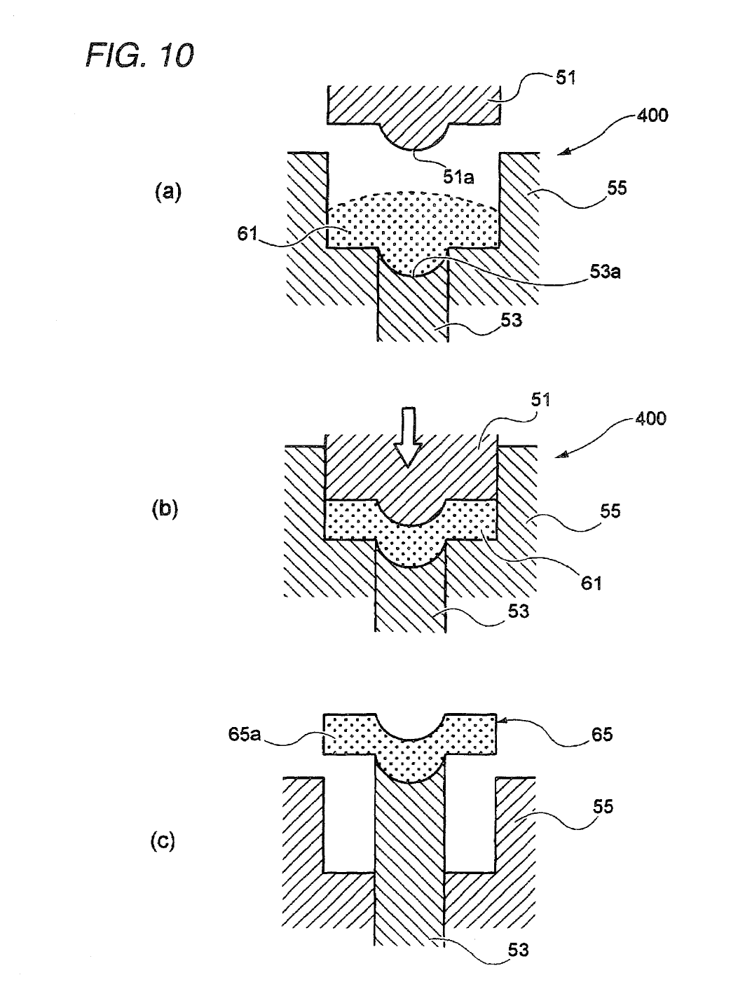

Next, a third embodiment of the optical member manufacturing method according to the invention will be described with reference to FIGS. 9 and 10.

FIG. 9 is a flowchart showing a schematic procedure of an optical member manufacturing method in the third embodiment, and FIG. 10 is an explanatory view showing a step of molding a preform directly from a nano composite powder by heat-compressing the nano composite powder.

In the schematic manufacturing method of the optical member in this embodiment, as shown in FIG. 9, a nano composite powder is put in a preform molding apparatus as it is, and molded into a preform having the shape close to the shape of a lens (optical member) through a heating step (S7) and a compression step (S8). Next, in a press molding step (S9) similar to that in the second embodiment, an optical ember that is a finished product is manufactured. This embodiment is different from the second embodiment in the preform molding method.

As shown in FIG. 10, a preform molding apparatus 400 includes at least an upper mold 51, a lower mold 53, and an external mold 55 to which the upper mold 51 and the lower mold 53 are fitted. A lower surface 51a of the upper mold 51 and an upper surface 53a of the lower mold 53 are formed respectively in the shape close to the shape of the optical member 67 that is a finished product. However, as long as the preform molding apparatus 400 can mold a preform 65 having the shape close to the shape of the optical member 67, it does not require comparatively accuracy. Accordingly, the manufacturing cost of the mold settles at an inexpensive cost.

The concrete procedure will be described. As shown in FIG. 10, a nano composite powder 61 is put, in a powdery state, on the lower mold 53 arranged in the external mold 55 (FIG. 10(a)), and pressed between the upper mold 51 and the lower mold 53 while being heated, thereby to be molded into a preform 65 (FIG. 10(b)). Next, the lower mold 53 is moved upward and the preform 65 is taken out from the preform molding apparatus 400 (FIG. 10(c)).

Further, as described before, when the preform 65 is molded, in case that the mold for the preform 65 is concave (in case of a convex lens), it is desirable that a curvature of the preform 65 surface is made larger than the product shape. Press conditions in this preform 65 molding time are similar to those in the press molding step of the intermediate body 63 in the first embodiment.

Generally, it is difficult to measure the weight of the nano composite powder 61 which is powdery in a short time and with good accuracy. In this embodiment, after the weight (volume) of the nano composite powder 61 has been roughly measured, the nano composite powder is put in the preform molding apparatus 400 and compression-molded into the preform 65 having the predetermined thickness. Hereby, the preform 65 taken out from the preform molding apparatus 400 has stably the shape close to the shape of the optical member 67. In this step, it is not necessary for the preform 65 to be subjected to weight (volume) control of high accuracy, but it is at the minimum necessary for the preform 65 to become a solid body from the powder body. Further, the molded preform 65 may be subjected to the work of bringing the shape of the preform 65 close to the finished shape if necessary, such as the work of cutting a peripheral portion of a flange 65a. In case that such the work is performed, the nano composite powder 61 to be put in the mold of the preform molding apparatus 400 is packed in the mold without particularly being conscious of the weight (volume), and the extra powder is absorbed in the flange 65a, whereby the preform molding step can be more simplified. Further, by bringing the shape of the preform close to the finished shape, working accuracy in the press molding step of the sequential stage can be heightened.

The preform 65 thus molded so as to have the shape close to the shape of the optical member 67 is put on a lower mold 35 in a pressure molding apparatus 200 as described in FIG. 8, and pressed in an external mold 37 between a upper mold 33 and the lower mold 35 while being heated, thereby to be molded in the product shape. Next, after the molded preform 65 has been cooled in a pressurized state, the upper and lower molds 33, 35 are opened. Hereby, the optical member 67 which is a product obtained by compression molding is taken out.

According to the manufacturing method in this embodiment, since the nano composite powder 61 in the powdery state is directly molded into the preform 65, handling property of the workpiece (preform) in the sequential step improves, and the number of operations in each step can be reduced, so that a molding cycle can be quickened.

Further, when the agglomerated preform is molded from the powder, in order to restrain the air remaining between the powders, which is shut up in the material, from causing poor transfer or a defect such as optical strain, the atmosphere in the compression-molding time may be made a CO₂ gas atmosphere, a nitrogen gas atmosphere, or a vacuum atmosphere. The CO₂ and the nitrogen are high in solubility in resin material, and do not shut up and remain in the material unlike the air.

Further, on reduction of the molding cycle, the atmosphere replacement with the CO₂ or the nitrogen is more advantage than the vacuum atmosphere for each compression molding. Further, the CO₂ atmosphere is more preferable because the CO₂ is higher in solubility than the nitrogen.

### Fourth Embodiment

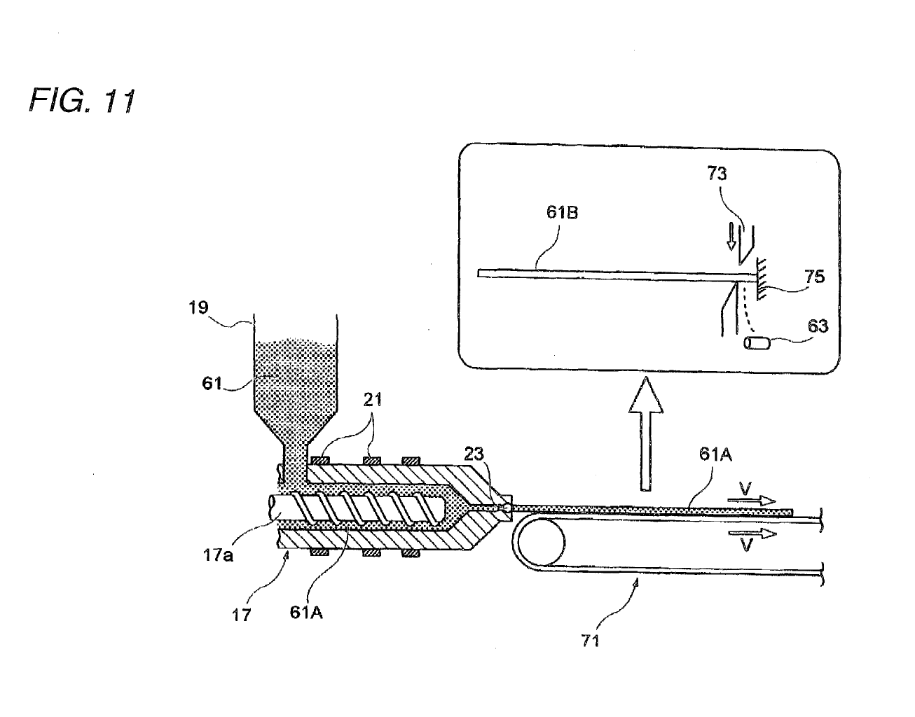

Next, a fourth embodiment of the optical member manufacturing method according to the invention will be described with reference FIG. 11.

FIG. 11 is an explanatory view showing an example of a step of preparing a rod-shaped nano composite material of which the cross section is fixed and cutting the rod-shaped nano composite material thereby to prepare an intermediate body.

In this embodiment, a nano composite material 61A ejected from a plasticizing mechanism 17 described in the first embodiment is extruded on a belt conveyer 71, thereby to prepare a rod-shaped nano composite material 61B of which the cross section is fixed. At this time, by rotating a screw 17a of the plasticizing mechanism 17 at a constant speed, extrusion is performed under a constant condition, so that the extrusion speed of the nano composite material 61A can be made constant with high accuracy. Further, the extruded nano composite material 61A is placed on the belt conveyer 71 of which the conveying speed is nearly matched with the ejection speed, whereby the rod-shaped nano composite material 61B of which the density and the cross section are made constant is obtained.

After the nano composite material 61B of which the density and the cross section are made constant has been prepared as described above, the rod-shaped nano composite material 61B is cut in a predetermined length thereby to obtain an intermediate body. As a cutting method, various methods such as cutting by laser heating can be adopted. For example, one end of the rod-shaped nano composite material 61B is pressed against an abutment portion 75, and the nano composite material 61B may be cut in a predetermined length by a cutter 73 installed apart from this abutment portion 75 by a predetermined distance. Hereby, the volume necessary to make a lens can be measured by measuring the length of the rod, so that weight (volume) control can be performed with high accuracy.

When the nano composite material 61B is cut by the cutter 73, similarly to in case of the cutter 31 in the first embodiment, the temperature of the cutter 73 is set at a higher temperature (about Tg+50° C.) than the glass transition temperature Tg of the nano composite material.

According to this embodiment, an extrusion step of preparing the rod-shaped nano composite material 61B, and a cutting step of cutting the rod-shaped nano composite material 61B in the desired length to obtain an intermediate body 63 can be performed independently of each other. Therefore, each step can be performed under the optimum environmental condition. For example, in case that the nano composite material 61B is cut in a state where its temperature is not decreased from the high temperature in the extrusion step, the dimensional error for thermal expansion is produced. However, in case that the cutting step is separate from the extrusion step, the nano composite material 61B can be cut in a sufficiently cooled state. Further, after many numbers of the rod-shaped nano composite materials 61B have been prepared in a lump, the cutting steps for their rod-shaped nano composite materials 61B can be also performed in a lump, which heightens productivity. Further, it becomes easy also to make the environmental temperature in the cutting step constant, so that working accuracy is heightened,

The invention is not limited to the aforesaid embodiments, but modifications and improvements can be appropriately made.

Next, the nano composite material (in which inorganic fine particles are contained in a thermoplastic resin) used in the optical member manufacturing method of the invention will be described below in detail.

Though the explanation of constituent features described below is made on the basis of the typical embodiment of the invention, the invention is not limited to such the embodiment.

### (Inorganic Fine Particle)

In organic and inorganic composite material used in the invention, the number average particle size of an inorganic fine particle is set to from 1 to 15 nm. In case that the number average particle size of the inorganic fine particle is too small, the feature inherent in the substance constituting the particle can change. To the contrary, in case that the number average particle size of the inorganic fine particle is too large, the influence of Rayleigh scattering becomes remarkable, so that transparency of the organic and inorganic composite material can decrease greatly. Accordingly, it is necessary to set the number average particle size of the inorganic fine particle in the invention to from 1 to 15 nm, preferably to from 2 to 13 nm, and more preferably to from 3 to 10 nm.

As the inorganic fine particle used in the invention, there are, for example, an oxide fine particle, a sulfide fine particle, a selenide fine particle, a telluride fine particle, and the like. More specifically, there are a titania fine particle, an oxide zinc fine particle, a zirconia fine particle, a tin oxide fine particle, a zinc sulfide fine particle, and the like. Preferably, there are the titania fine particle, the zirconia fine particle, and the zinc sulfide fine particle, and there are more preferably the titania fine particle and the zirconia fine particle. However, the inorganic fine particle is not limited to these particles. In the invention, one kind of inorganic fine particle may be used, or plural kinds of particles may be used together. Further, like a core-shell-type particle, the core and the outside are different in composition.

A refractive index in a wavelength 589 nm of the inorganic fine particle used in the invention is preferably from 1.90 to 3.00, more preferably from 1.90 to 2.70, and still more preferably from 2.00 to 2.70. In case that the inorganic fine particle of which the refractive index is 1.90 or more is used, the organic and inorganic composite material of which the refractive index is larger than 1.65 is easily prepared. In case that the difference of the refractive index between the particle and resin is large, scattering easily arises. Therefore, when the inorganic fine particle of which the refractive index is 3.00 or less is used, there is a tendency that the organic and inorganic composite material of which transmissivity is 80% or higher is easily prepared. The refractive index in the invention is a value measured by an Abbe refractometer (DR-M4 by ATAGO CO., LTD.) in relation to the light having a wavelength 589 nm at a temperature of 25° C.

### (Thermoplastic Resin)

The thermoplastic resin for use in the present invention is not particularly limited in its structure, and examples thereof include a resin having a known structure, such as poly(meth)acrylic acid ester, polystyrene, polyamide, polyvinyl ether, polyvinyl ester, polyvinyl carbazole, polyolefin, polyester, polycarbonate, polyurethane, polythiourethane, polyimide, polyether, polythioether, polyether ketone, polysulfone and polyethersulfone. Above all, in the present invention, a thermoplastic resin having, at the polymer chain terminal or in the side chain, a functional group capable of forming an arbitrary chemical bond with an inorganic fine particle is preferred. Preferred examples of such a thermoplastic resin include:

(1) a thermoplastic resin having a functional group selected from the followings at the polymer chain terminal or in the side chain:

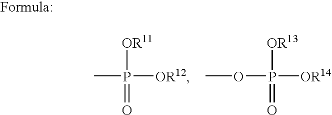

(wherein R¹¹, R¹², R¹³ and R¹⁴ each independently represents a hydrogen atom, a substituted or unsubstituted alkyl group, a substituted or unsubstituted alkenyl group, a substituted or unsubstituted alkynyl group, or a substituted or unsubstituted aryl group), —SO₃H, —OSO₃H, —CO₂H and —Si(OR¹⁵)ₘ₁R¹⁶₃₋ₘ₁ (wherein R¹⁵ and R¹⁶ each independently represents a hydrogen atom, a substituted or unsubstituted alkyl group, a substituted or unsubstituted alkenyl group, a substituted or unsubstituted alkynyl group, or a substituted or unsubstituted aryl group, and m1 represents an integer of 1 to 3); and

(2) a block copolymer composed of a hydrophobic segment and a hydrophilic segment.

The thermoplastic resin (1) is described in detail below.

### Thermoplastic Resin (1):

The thermoplastic resin (1) for use in the present invention has, at the polymer chain terminal or in the side chain, a functional group capable of forming a chemical bond with an inorganic fine particle. The “chemical bond” as used herein includes, for example, a covalent bond, an ionic bond, a coordination bond and a hydrogen bond, and in the case where a plurality of functional groups are present, each functional group may form a different chemical bond with an inorganic fine particle. Whether or not a chemical bond can be formed is judged by when a thermoplastic resin and an inorganic fine particle are mixed in an organic solvent, whether or not the functional group of the thermoplastic resin can form a chemical bond with the inorganic fine particle. The functional groups of the thermoplastic resin all may form a chemical bond with an inorganic fine particle, or a part thereof may form a chemical bond with an inorganic fine particle.

The thermoplastic resin for use in the present invention is preferably a copolymer having a repeating unit represented by the following formula (1). Such a copolymer can be obtained by copolymerizing a vinyl monomer represented by the following formula (2).

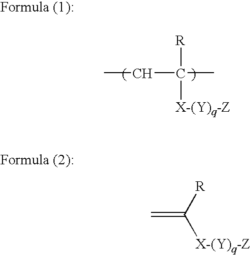

In formulae (1) and (2), R represents a hydrogen atom, a halogen atom or a methyl group, and X represents a divalent linking group selected from the group consisting of —CO₂—, —OCO—, —CONH—, —OCONH—, —OCOO—, —O—, —S—, —NH— and a substituted or unsubstituted arylene group and is preferably —CO₂— or a p-phenylene group.

Y represents a divalent linking group having a carbon number of 1 to 30, and the carbon number is preferably from 1 to 20, more preferably from 2 to 10, still more preferably from 2 to 5. Specific examples thereof include an alkylene group, an alkyleneoxy group, an alkyleneoxycarbonyl group, an arylene group, an aryleneoxy group, an aryleneoxycarbonyl group, and a group comprising a combination thereof. Among these, an alkylene group is preferred.

q represents an integer of 0 to 18 and is preferably an integer of 0 to 10, more preferably an integer of 0 to 5, still more preferably an integer of 0 to 1.

Z is a functional group shown in the Formula above.

Specific examples of the monomer represented by formula (2) are set forth below, but the monomer which can be used in the present invention is not limited thereto.

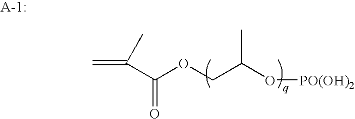

A mixture of q=5 and 6.

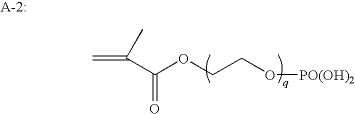

A mixture of q=4 and 5.

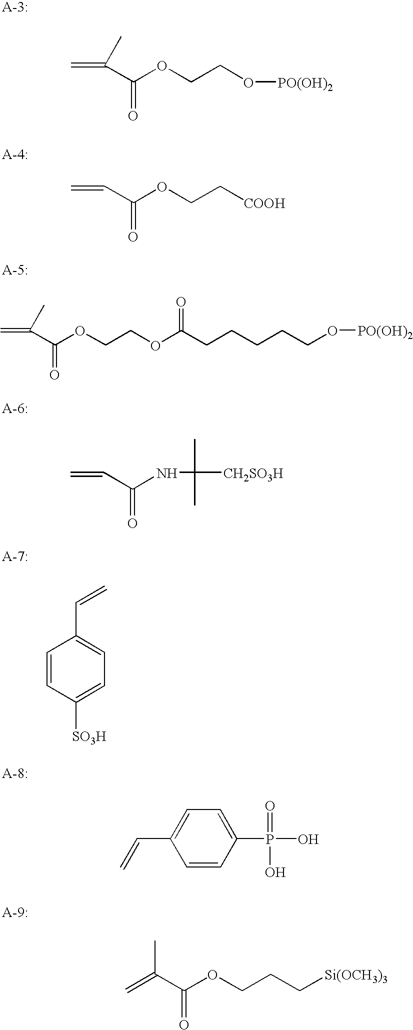

In the present invention, as for other kinds of monomers copolymerizable with the monomer represented by formula (2), those described in J. Brandrup, Polymer Handbook, 2nd ed., Chapter 2, pp. 1-483, Wiley Interscience (1975) may be used.

Specific examples thereof include a compound having one addition-polymerizable unsaturated bond, selected from styrene derivatives, 1-vinylnaphthalene, 2-vinylnaphthalene, vinylcarbazole, acrylic acid, methacrylic acid, acrylic acid esters, methacrylic acid esters, acrylamides, methacrylamides, allyl compounds, vinyl ethers, vinyl esters, dialkyl itaconates, and dialkyl esters or monoalkyl esters of the fumaric acid above.

The weight average molecular weight of the thermoplastic resin (1) for use in the present invention is preferably from 1,000 to 500,000, more preferably from 3,000 to 300,000, still more preferably from 10,000 to 100,000. When the weight average molecular weight of the thermoplastic resin (1) is 500,000 or less, the forming processability tends to be enhanced, and when it is 1,000 or more, the dynamic strength tends to be enhanced.

In the thermoplastic resin (1) for use in the present invention, the number of functional groups bonded to an inorganic fine particle is preferably, on average, from 0.1 to 20, more preferably from 0.5 to 10, still more preferably from 1 to 5, per one polymer chain. When the number of the functional groups is 20 or less on average per one polymer chain, the thermoplastic resin (1) tends to be prevented from coordination to a plurality of inorganic fine particles to cause viscosity elevation or gelling in the solution state, and when the average number of functional groups is 0.1 or more per one polymer chain, this tends to yield stable dispersion of inorganic fine particles.

In the thermoplastic resin used in the invention, the glass transition temperature is preferably from 80 to 400° C., and more preferably from 130 to 380° C. In case that the resin having the glass transition temperature of 80° C. or more is used, an optical member having the sufficient heat-resistance is readily obtained. Further, in case that the resin having the glass transition temperature of 400° C. or less is used, there is a tendency for molding to be readily performed.

As described above, in the nano composite material that is the material of the optical member according to the invention, by providing the unit structure of the specific structure also in the resin, without impairing high refractivity and high transparency of the organic and inorganic composite material in which inorganic fine particles are dispersed, mold releasability from the mold can be improved.

According to the above materials, there can be provided the organic and inorganic composite material having the excellent mold-releasability, the high refractivity and the high transparency; and the optical member which is constituted by including its organic and inorganic composite material, and has the high accuracy, the high refractivity and the high transparency.

Next, a manufacturing method of the powdery nano composite material used in the above respective embodiments will be briefly described.

In the nano composite material in the embodiments, the above-mentioned inorganic fine particle is mixed with the thermoplastic resin in the solvent such as an organic solvent. By removing the solvent from the prepared nano composite solution, a powdery nano composite material is obtained.

It is preferable from a viewpoint of quick drying that the average particle diameter of this nano composite powder is set to 1 mm or less. For example, in case that the solution in which the resin and the inorganic fine particles are dispersed are made into fine liquid droplets, and their liquid droplets are dried and made powdery, when the average particle diameter of the powder is 1 mm or less, the increase of the surface area quickens drying. Further, when the average particle diameter exceeds 1 mm, the time till drying is completed becomes long, which causes the increase in man-hour.

As a method of removing the solvent from the above nano composite solution, various types of drying methods are applicable, for example, a heat-transfer drying type, an internal heat-generation drying type, and non-heating drying type. Specifically, there are chamber drying, tunnel type drying, band type drying, rotary drying, through-flow rotary drying, agitated trough drying, fluidized bed drying, a spray dryer, pneumatic conveying drying, vacuum-freeze drying, vacuum drying, infrared drying, internal heat-generation drying, and a tubular drier. However, the drying methods are not limited to these types. Further, two or more of the above drying types may be combined.

In case of the nano composite resin solution, similarly to in case of the usual resin solution, when the density of the nano composite resin is increased by drying, viscosity of the solution increases, so that there is a property that the diffusion speed of the solvent lowers sharply. Therefore, the drying method in which the surface area for drying is larger is more desirable. Accordingly, specifically, the rotary drying, the through-flow rotary drying, the agitated trough drying, the fluidized bed drying, the spray dryer, the pneumatic conveying drying, and the vacuum-freeze drying are desirable. In case of the pneumatic conveying drying, the solution may be made into liquid droplets (disintegrated) if necessary by a rotary disperser, a disintegrator, an ink jet head, or a dispenser head.

In order to improve productivity, the larger the surface is, the more quickly drying is performed. Specifically, it is preferable that the solution is disintegrated to be dried so that the average diameter of the powder after drying becomes 2 mm or less, and more preferably 0.5 mm or less. Accordingly, as the drying method, the spray dryer and the pneumatic conveying drying are more preferable.

In order to prevent deterioration (coloring, mixing of a foreign substance, or poor dispersion of fine particle) due to heat, it is preferable that a load of heat on the material in the drying time is smaller. Specifically, the spray dryer, the pneumatic conveying drying, the vacuum drying, and the vacuum-freeze drying are more preferable.

From a viewpoint of productivity, it is good that the drying time is shorter. Therefore, the above drying methods may be combined. In order to improve drying rate (in order to reduce the amount of the residual solvent), the vacuum drying may be used after the above drying.

Further, before the above drying, the material may be concentrated by precipitation by means of a centrifugal method, pressure filtration, or re-precipitation. The liquid viscosity in the spray drying time is preferably 1000 cP or less, more preferably 500 cP or less, and still more preferably 100 cP or less (the liquid viscosity can be adjusted by the density of the solution).

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2007-95372 filed Mar. 30, 2007, the contents of which are incorporated herein by reference.

1. A method for manufacturing an optical member from a powdery nano composite material which includes a thermoplastic resin containing inorganic fine particles,
the method comprising:
preparing an aggregated intermediate body by heating the powdery nano composite material; and
forming the optical member having a finished shape by heat-press molding the intermediate body.

2. The method according to claim 1, wherein one aggregate of the intermediate body is formed into one optical member.

3. The method according to claim 1, wherein the powdery nano composite material has an average particle diameter of 1 mm or less.

4. The method according to claim 1, further comprising, after the preparing of the intermediate body, preparing a preform having a shape close to the finished shape by heat-compressing the intermediate body,
wherein the forming of the optical member is performed by forming an optical function surface on both sides of the preform.

5. The method according to claim 1, wherein the preparing of the intermediate body includes: heating and melting the powdery nano composite material; extruding the melted nano composite material by extrusion molding; and cutting a volume of the extruded nano composite material to prepare the intermediate body.

6. The method according to claim 1, wherein the preparing of the intermediate body includes: heating and melting the powdery nano composite material; extruding a rod-shaped body of the melted nano composite material by extrusion molding, the rod-shaped body having a constant cross section; and cutting the rod-shaped body to prepare the intermediate body.

7. The method according to claim 1, wherein the preparing of the intermediate body includes heat-compressing the powdery nano composite material to form an intermediate body having a shape close to the finished shape.

8. An optical member manufacturing apparatus that forms an optical member from a powdery nano composite material which includes a thermoplastic resin containing inorganic fine particles, the apparatus comprising:
a first forming unit that accommodates the powdery nano composite material in a container and heats the powdery nano composite material to prepare an agglomerate intermediate body; and
a second forming unit including at least two molds having optical function surfaces to be transferred onto the intermediate body, wherein the intermediate body is sandwiched between the molds and heat-press molded.

9. The optical member manufacturing apparatus according to claim 8, wherein the first forming unit includes:
a heating unit that heats the powdery nano composite material accommodated in the container;
an extrusion-molding unit that extrusion-molds the nano composite material melted by heating; and
a cutting unit that cuts the extruded nano composite material by an amount.

10. An optical member formed by a method according to claim 1.

11. The optical member according to claim 10, which is a lens.
